(19) United States
(12) Patent Application Publication
(10) Pub. No.: US 2009/0291309 A1
(43) Pub. Date: Nov. 26, 2009

(54) Material Containing Microcapsules, In Particular Phase-Changing Materials

(76) Inventors: Fabien Salaün, Roubaix (FR); Eric Devaux, Sainghien-en-Weppes (FR); Serge Bourbigot, Villeneuve D' Ascq (FR); Pascal Rumeau, Trevoux (FR)

Correspondence Address: KENYON & KENYON LLP, 1500 K STREET N.W., SUITE 700, WASHINGTON, DC, 20005, US

(21) Appl. No.: 11/792,710

(22) PCT Filed: Nov. 30, 2005
(86) PCT No.: PCT/FR05/02986

§ 371 Date: Nov. 16, 2007

(30) Foreign Application Priority Data
Dec. 14, 2004 (FR) 0413289

(51) Int. Cl. B01J 13/22; B01J 13/02; B01J 13/04; B01J 13/14; C09K 3/00

(52) U.S. Cl. 428/402.2; 428/402.24; 264/4.1; 264/4.3; 427/213.34; 427/213.31; 252/182.12; 252/182.23

(57) ABSTRACT

The present invention relates to aminoplast-membrane single-core or multi-core microcapsules whose core is comprised of at least two organic and/or inorganic compounds. The invention also relates to methods of preparing said microcapsules.

The present invention relates to the field of thermal insulation and concerns more particularly microcapsules comprised of at least two organic and/or inorganic compounds.

Traditionally, thermoregulating textiles are comprised of composite materials in which trapped air is the principal insulating element. Developed initially for the production of liquid coolants, solar energy storage systems and heat-exchange sources for heating and air conditioning, phase-change materials are now also used in the manufacture of fibers, fabrics and thermoregulating foams for garments. Indeed, phase-change materials, which are liquids that solidify at moderately low temperatures or solids that liquefy at higher temperatures, are suitable as thermoregulating materials for the majority of temperatures to which the human body is exposed.

Since these materials are from time to time in the liquid state, they are not easily applicable to textile substrates without being contained in a capsule. To facilitate their impregnation or incorporation in or on various substrates, they must be as small as possible to facilitate binding to the textile and also to increase specific contact surface area, which consequently improves thermoregulation. For these various reasons, phase-change materials applied to or integrated in textile substrates are generally microencapsulated by polymers.

Microencapsulation also improves heat transfer by increasing specific contact surface area, thus helping compensate for low thermal conductivity, but also by avoiding diffusion of the active ingredient, all while controlling variations in volume during exposure to various thermal challenges. In the case of an organic phase-change material, microencapsulation reduces, even eliminates, its reactivity with the external environment.

Microencapsulation techniques vary depending on the types of products used and the final application sought; nevertheless, they all begin with an oil-in-water or water-in-oil emulsion depending on the solubility of the active ingredient in one of the two phases. In most cases, the polymer encapsulating the droplets is introduced in the form of monomers at the same time as the active ingredient.

Many microencapsulation methods report the formation of an aminoplast membrane encapsulating the active ingredient; due to their various advantages, amino resins are used for this purpose. The application of amino resins as polymers constituting the membranes of microcapsules represents an advantageous economic alternative compared to the large-scale methods currently used, such as phase separation and interfacial polymerization, primarily due to the availability and low cost of raw materials such as urea, melamine, dicyandiamide and formaldehyde, and to simple encapsulation techniques.

The object of the present invention is to propose aminoplast-membrane microcapsules, comprising in particular phase-change materials, which exhibit novel structures and improved thermal properties, as well as to propose methods of preparation of said microcapsules.

According to a first aspect, the invention relates to single-core or multi-core aminoplast-membrane microcapsules comprised of at least two organic and/or inorganic compounds.

In one embodiment, the microcapsules according to the invention are single-core and have a conventional core-shell structure whose membrane or external aminoplast wall represents the shell. Said shell envelopes the core, which characteristically comprises at least two organic and/or inorganic compounds.

Preferably, the single-core microcapsules comprise a mixture of at least two paraffins. According to one embodiment, said paraffins are even alkanes, for example alkanes selected from the group comprising hexadecane, octadecane and eicosane.

In another embodiment, the microcapsules according to the invention are multi-core and comprise at least one organic compound surrounded by microspheres comprising at least one inorganic compound, said microspheres being coated by the amino resin. According to one embodiment, said organic compound is a paraffin, for example hexadecane or eicosane. Said inorganic compound can be a phase-change compound, for example a hydrate salt, or a non-phase-change compound, for example a phosphate salt.

Advantageously, the microcapsules according to the invention comprised of at least two organic and/or inorganic compounds, of which at least one is a phase-change compound, have thermal windows that cover wider temperature ranges than those corresponding to microcapsules enclosing a single phase-change material.

According to a second aspect, the invention relates to a method of synthesis of the single-core microcapsules mentioned above, wherein said method comprises the following steps:
a) introduce into a mixer, in an aqueous solution, a base composition A comprising:
   a mixture of at least two paraffins,
   an aminoplast pre-polymer,
   a surfactant;
b) operate the mixer at a speed between 9,000 rpm and 14,000 rpm, at a temperature of approximately 40° C. and a pH of approximately 4 for 10 to 20 minutes, so as to emulsify and homogenize said composition, until a stable emulsion is obtained;
c) increase the temperature of the emulsion to approximately 55° C. and adjust the speed of the mixer to approximately 600 rpm for approximately 4 hours so as to obtain microcapsules.

According to a third aspect, the invention relates to a method of synthesis of the multi-core microcapsules mentioned above, wherein said method comprises:
a step of microencapsulation of the inorganic compound in a paraffinic medium; and
a step of formation of microcapsules and of synthesis of the aminoplast membrane.

According to other aspects, the invention relates to the various compositions produced from the microencapsulation methods disclosed.

The invention will now be described in detail.

According to the first aspect, the invention relates to single-core or multi-core aminoplast-membrane microcapsules comprised of at least two organic and/or inorganic compounds.

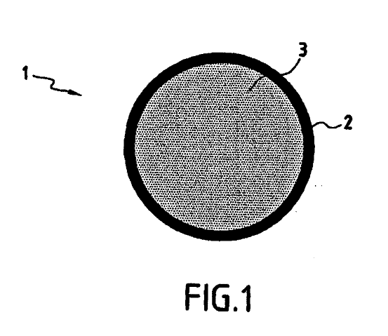

In one embodiment, the microcapsules 1 of the invention, represented diagrammatically in FIG. 1, are single-core and have a conventional core-shell structure whose membrane or external aminoplast wall 2 represents the shell, said shell enveloping core 3 which characteristically comprises at least two organic and/or inorganic compounds.

Initially, the applicants developed a novel mixture of at least two organic phase-change materials, said mixture also being formulated with a mineral load, which yielded a thermoregulating system with an improved thermal window and energy balance.

Preferably, the organic phase-change materials used are paraffins or n-alkanes due to their thermal characteristics with phase-change enthalpies of approximately 200 J/g.

Among the existing n-alkanes that are likely to be suitable for textile thermoregulation, none have a sufficiently broad thermal window in the 19° C. to 30° C. temperature range. The odd n-alkanes appear of little use considering the presence of a low-energy solid-solid transition and a lower solid-liquid phase-change enthalpy than even n-alkanes, as well as their approximately four-fold higher cost than even n-alkanes. Thus were chosen binary mixtures of three alkanes, namely hexadecane (C16), octadecane (C18) and eicosane (C20); more particularly, a mixture of hexadecane and eicosane was chosen due to their respective melting temperatures being on either side of those required for a textile application.

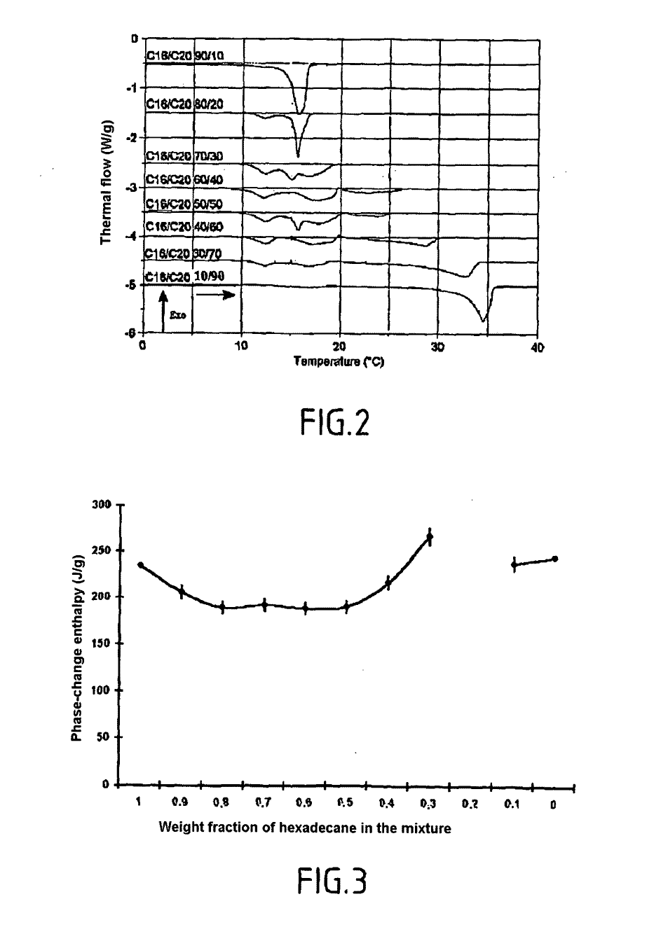

The enthalpies of the hexadecane/eicosane mixture in various proportions were characterized using 3 mg samples and a 0.5° C./min temperature ramp, thus dissociating the peaks relative to the various transitions. The stacked traces presented in FIG. 2 show that when one of the compounds is predominant in the mixture, the phase-transition thermal window is narrow and tend towards that of the melting temperature of the alkane in the larger proportion. On the other hand, for mass concentrations between 0.3 and 0.7, a widening of peaks between 0° C. and 35° C. is observed, implying the appearance of new solid-solid transitions within the material during the rise in temperature. The mass concentration of paraffin introduced into the single-core microcapsules is preferably between 25% and 75%.

The measurement of enthalpies, represented in FIG. 3, vary between those of the pure substances and 190 J/g, except in the particular case of the hexadecane/eicosane mixture in a proportion of 30/70. Thus, widening the thermal window is accompanied by a reduction of approximately 20% in the total enthalpy of the phase changes.

This loss is related to the increase in the number of solid-solid transitions that are less energetic than solid-liquid transitions. The 50/50 mixture makes it possible to use the material over a broader thermal window, observed to be from 3° C. to 32° C. for an enthalpy of 190 J/g.

The applicants have demonstrated that the introduction in the C16/C20 binary mixture of a soluble load in one or the other of its components increases the energy balance up to values comparable with those of pure substances, without modifying the thermal window.

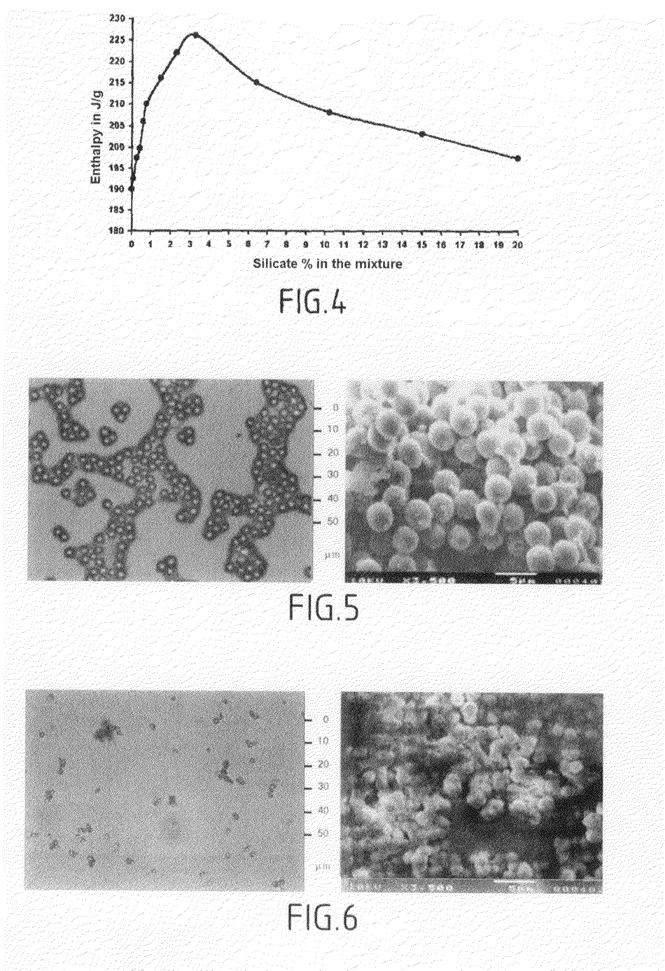

In one embodiment, the C16/C20 binary mixture is supplemented with tetraethylorthosilicate. The results obtained, represented in FIG. 4, show that enthalpy increases up to approximately 4% (by weight) of tetraethylorthosilicate and then it decreases until reaching its base level at 20% of load.

Subsequently, the applicants developed a method of microencapsulating mixtures of at least two organic phase-change components described previously.

For this purpose and according to the second aspect, the invention discloses a method of synthesis of single-core microcapsules, wherein said method comprises the following steps:
a) introduce into a mixer, in an aqueous solution, a base composition A comprising:
   a mixture of at least two paraffins,
   an aminoplast pre-polymer,
   a surfactant;
b) operate the mixer at a speed between 9,000 rpm and 14,000 rpm, at a temperature of approximately 40° C. and a pH of approximately 4 for 10 to 20 minutes, so as to emulsify and homogenize said composition, until a stable emulsion is obtained;
c) increase the temperature of the emulsion to approximately 55° C. and adjust the speed of the mixer to approximately 600 rpm for approximately 4 hours so as to obtain microcapsules.

In a preferred embodiment, the encapsulation protocol is based on water-continuous emulsion of the paraffin mixture in an aqueous solution containing an aminoplast pre-polymer (methoxymethylmelamine). The emulsion is achieved using a rotor-stator for approximately 15 minutes. Synthesis continues by increasing the temperature of the solution to 55° C. for 4 hours at 700 rpm, thus allowing suspension of the particles. The microcapsules obtained are filtered, washed with methanol and then with demineralized water, and oven-dried at 35° C. overnight. In this protocol, the surfactant used to stabilize the emulsion is Tween® 80.

The method of synthesis of single-core microcapsules will be better understood upon consideration of the description, which will refer to the following non-limiting examples.

### EXAMPLE 1

### Influence of Emulsion Conditions: pH, Temperature and Shearing

Table 1 below illustrates the results of nine tests in which the granulometry, morphology and synthesis yield of single-core microcapsules are studied as a function of variations in pH, temperature and choice of pre-polymer.

TABLE 1

| Test | Pre-polymer* | | Paraffin | Water | pH 4 Emulsion | | Shearing |
|---|---|---|---|---|---|---|---|
| number | number (g) | | (g) | (g) | Encapsulation | | (rpm) |
| 1 | 1 | 25 | 10 | 50 | − | + | 13,500 |
| 2 | 2 | 25 | 10 | 50 | + | + | 13,500 |
| 3 | 3 | 25 | 10 | 50 | + | + | 9,500 |
| 4 | 4 | 12.5 | 10 | 58.65 | + | + | 9,500 |
| 5 | 5 | 36 | 10 | 42.3 | + | + | 9,500 |
| 6 | 6 | 72 | 10 | 0 | + | + | 9,500 |
| 7 | 7 | 72 | 10 | 0 | + | + | 9,500 |
| 8 | 8 | 72 | 10 | 0 | + | + | 9,500 |

(*70% by weight in aqueous solution)

Adjustment of the pH of the solution during the emulsion makes it possible to better stabilize the emulsion by means of intramolecular interactions. During these syntheses, the emulsion was maintained at 40° C. The drop in pH at this temperature conditions the formation of the primary microcapsule membrane at the same time that droplet deformation and rupture mechanisms occur under strong shearing. Thus it can be observed in FIGS. 5 and 6 that the granulometry seen in the SEM and optical images from test 2 is finer than that of test 1 (FIG. 5: optical (×64) and SEM (×3,500) images of the microcapsules of synthesis test 1; FIG. 6: optical (×64) and SEM (×3,500) images of the microcapsules of synthesis test 2).

Nonionic surfactants, in particular Tween® 80, are sensitive to temperature increases. The formation of an emulsion that is stable at 40° C. is not inevitable, and in any case may not preserve its granulometry during the increase in temperature. In the present case, this increase is accompanied by mechanical agitation of the system using an anchor. The droplets formed are then likely to coalesce when the system solidifies by the formation of the primary membrane.

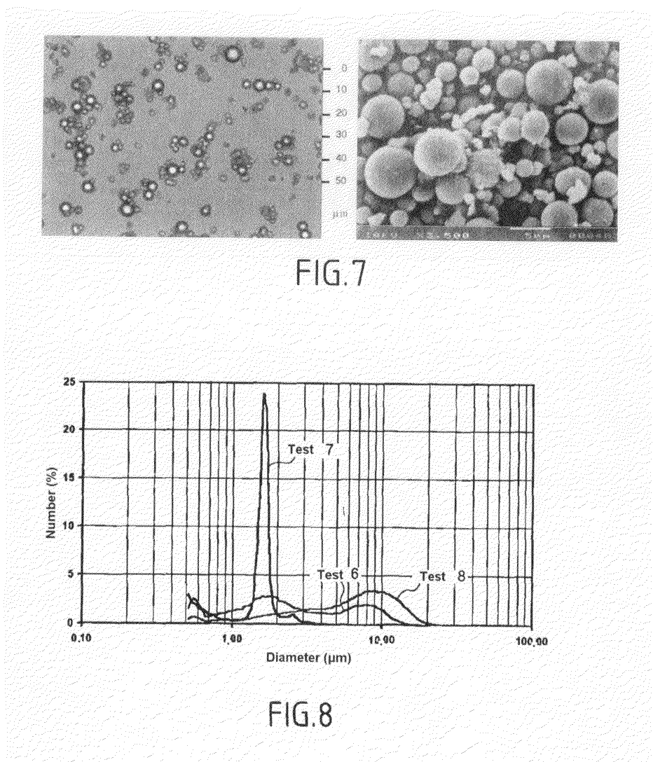

The other factor likely to influence granulometry is the shearing stress applied to the phases. The fact of passing from a speed of 9,500 rpm to 13,500 rpm during the emulsion strongly alters not only the mean diameter but also the size distribution within the emulsion and consequently those of the microcapsules. FIG. 7 illustrates test 3. The size distribution seen in the SEM image shows a wide distribution of sizes with the diameter clearly ranging between 1 μm and 5 μm.

### EXAMPLE 2

### Choice of Pre-Polymer

Various types of amino resins have been formulated by modifying the formaldehyde/melamine (F/M) molar ratio.

The fact that the F/M ratio influences the reaction kinetics has as a consequence the modification of synthesis granulometry and particle morphology. Indeed, the larger the ratio the more favored is the formation of ether bridges and the shorter is phase-separation time. Granulometric analysis of the syntheses shows that the larger the ratio (tests 6 and 8) the wider the distribution of mean diameter, as illustrated in FIG. 8; at a low ratio (test 7) the distribution is centered on a mean value of 1.8 μm. It should also be noted that the bimodal distribution changes between test 6 and test 8 with a decrease in the number of particles of smaller mean diameter to the benefit of the distribution of 8 μm particles when the ratio is increased. The difference in granulometry is not directly related to the ratio, but a low ratio leads to higher surface activity on the part of the resin and its solubility in the aqueous medium is lower, which also facilitates the emulsification of the system.

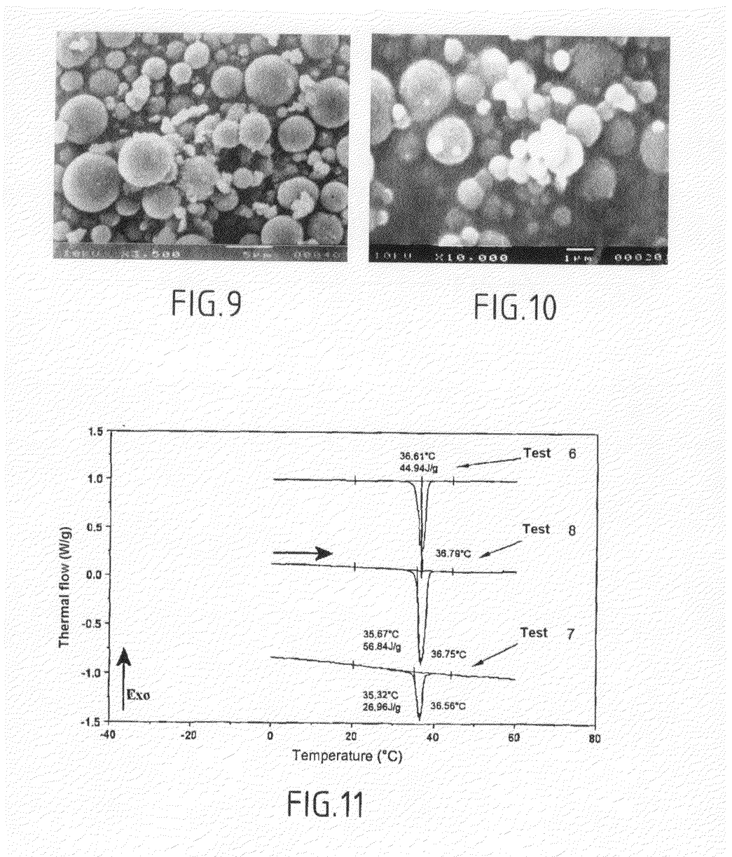

Microcapsule morphology is also altered by F/M ratio. The lower the F/M ratio, the smoother the walls of the capsules appear, whereas a high ratio leads to the formation of a rougher surface, as illustrated in FIG. 9 (SEM image (×3,500) of the microcapsules of synthesis test 3) and FIG. 10 (SEM image (×10,000) of the microcapsules of synthesis test 7).

The presence of paraffins in the microcapsule core is easily detectable by DSC. It is observed that the efficiency of the method is also related to F/M ratio. The higher the F/M ratio the better the encapsulation and the higher the ratio of resin forming the membrane, expressed by an increase in microcapsule phase-transition enthalpy. The lower the ratio the more the microcapsules become fragile and breakable. Thus, the choice of a high resin ratio ensures the recovery of all of the synthesized particles. The thermograms of tests 1, 6 and 8 at 2° C./min are presented in FIG. 11.

### EXAMPLE 3

### Influence of Pre-Polymer Quantity

The quantity of pre-polymer introduced changes more or less markedly the viscosity of the aqueous phase. This viscosity change is likely to decrease the size distribution of the emulsion and consequently that of the microcapsules; however, this effect is limited by the increase in the thickness of the membrane. Thus, two competitive phenomena are present. The measurement of the viscosity of the aqueous phases during tests 3, 4, 5 and 6 shows an increase with the increase in the quantity of pre-polymer introduced, as shown in table 2. Measurements are taken using a Brookfield viscometer at 20° C. with a no. 1 mixing rotor turning at 20 rpm. These differences are sufficiently adequate to modify the fractionation of the paraffin droplets and to modify the final granulometry of the microcapsules. The results of the viscosity ratio calculations are in accordance with the literature, thus suggesting the establishment of a unimodal size distribution during the paraffin emulsification step for the first two tests, and a bimodal trend for the two others.

TABLE 2

| Test | Viscosity of the aqueous | Ratio of viscosities with |
|---|---|---|
| number | phase (mPa · s) | hexadecane |
| 3 | 8 | 0.41 |
| 4 | 1.5-1.8 | 1.83 |
| 5 | 14 | 0.24 |
| 6 | 50 | 0.07 |

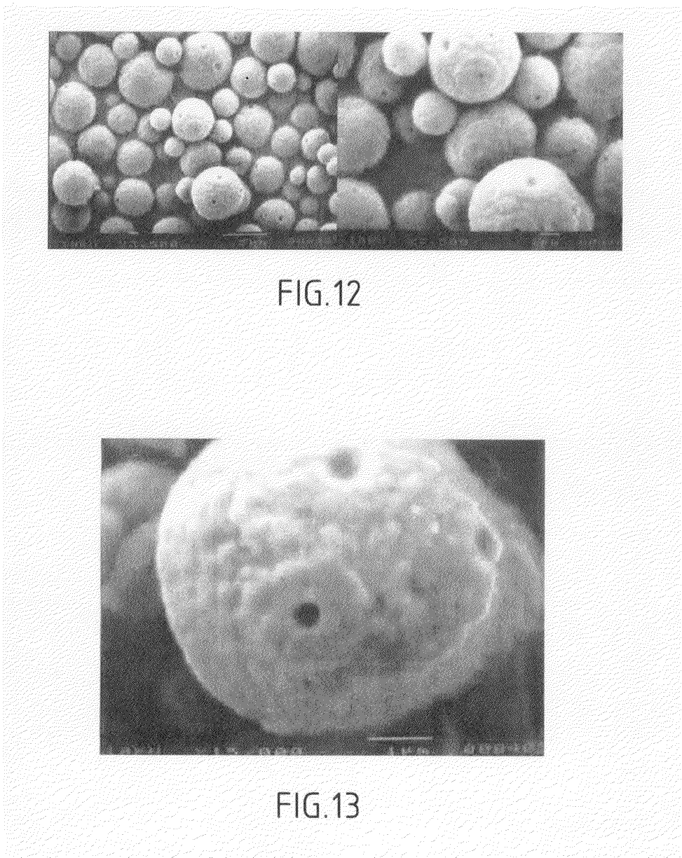

Microcapsule morphology is also affected by the ratio of pre-polymer introduced. Thus, an increase leads to a granular surface and the development of particles similar to berries. Observations under the scanning electron microscope (SEM) (FIG. 12: SEM images (×3,500 and ×7,500) and FIG. 13: SEM image (×15,000) of synthesis test 5 microcapsules) suggest a formation mechanism closer to phase coacervation than to in-situ polymerization, which is related to a decrease in the solubility of the pre-polymer in the aqueous phase by the presence of an acid pH and to the increase in temperature, thus leading to the formation of bridges between the triazinic groups.

Thus, the membrane formation mechanism proceeds in three distinct steps:
formation of fine aggregates or coacervates (premature particles) by condensation of oligomers in an aqueous medium;
diffusion of coacervates towards the paraffin droplets and coalescence of these particles;
consolidation of the membrane by bridging of these particles.

Consequently, a microcapsule appears to be comprised of aminoplast precursors that can be formed immediately without liquid-liquid separation of the aqueous phase at the interface of the organic phase droplets. The membrane of single-core capsules has a thickness between 120 nm and 700 nm.

Another object of the invention is a base composition A, implemented in the single-core microcapsule synthesis method described above, wherein said composition comprises, in an aqueous solution:
a blended mixture of at least two paraffins,
an aminoplast pre-polymer,
a surfactant,
optionally a soluble load in said mixture,
   and wherein the mixture ratio of paraffins to pre-polymer aminoplast is between 20% and 80% by weight.

According to one embodiment, the surfactant is a mixture (50/50 by volume) of Tween® 20 and Brij® 35, at 4% by weight with respect to the aqueous phase.

Preferably, the aminoplast pre-polymer has a molar ratio of formaldehyde to melamine of greater than 4.

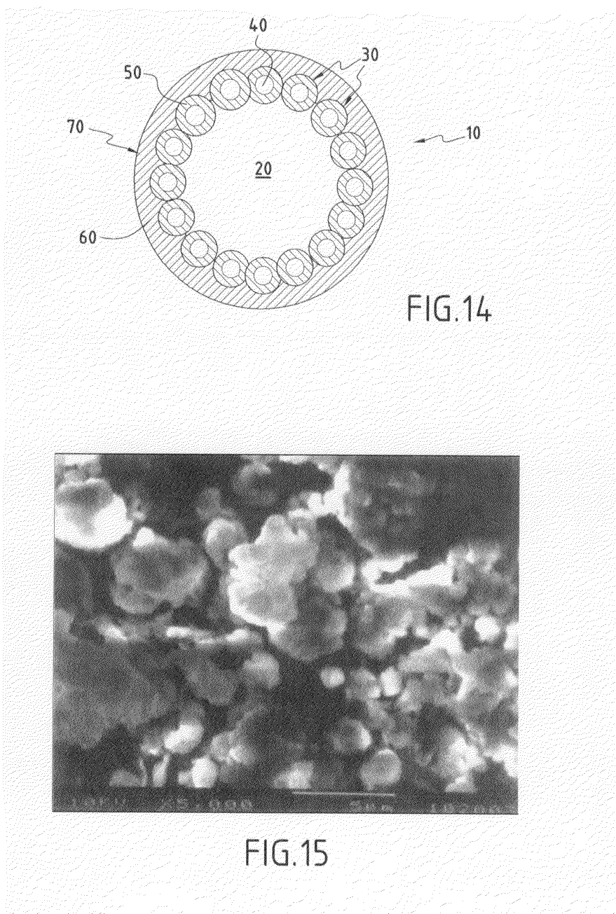

Still according to the first aspect, the invention relates to microcapsules having a novel multi-core structure (represented diagrammatically in FIG. 14). A microcapsule 10 comprises at least one organic compound 20 surrounded by microspheres 30 comprising at least one inorganic compound 40 and one membrane 50. Said microspheres 30 are coated by the external aminoplast membrane 60. The multi-core wall 70 encapsulating at least one organic compound 20 is formed from the aminoplast membrane 60 and the microsphere shell 30.

In one embodiment, said organic compound is a paraffin, for example hexadecane or eicosane, and said inorganic compound is a phase-change material, for example a hydrate salt.

In another embodiment, said organic compound is a paraffin and said inorganic compound is a non-phase-change material, for example a phosphate salt.

According to the third aspect, the invention relates to a multi-core microcapsule synthesis method mentioned above, wherein said method comprises:
a step of microencapsulation of the inorganic compound in a paraffinic medium; and
a step of microcapsule formation and of aminoplast membrane synthesis.

The step of microencapsulation of the inorganic compound in a paraffinic medium comprises the following operations:
i) introduce into a first mixer a composition B comprising two phases, an aqueous phase containing an inorganic compound and water and a continuous phase containing paraffin and a mixture of surfactants, the mixture of surfactants having an HLB (hydrophilic-lipophilic balance) between 5 and 7,
ii) operate the first mixer at a speed of 8,500 rpm for approximately 15 min at approximately room temperature so as to emulsify composition B until a stable emulsion E1 is obtained,
iii) introduce into a second mixer a composition C comprised of two phases, an aqueous phase containing an aqueous solution of PVA and a continuous phase containing a paraffin;
iv) operate the second mixer at room temperature at a speed of approximately 13,500 rpm so as to emulsify composition C until a stable emulsion E2 is obtained,
v) mix emulsions E1 and E2 to obtain a microgel,
vi) add to the microgel a cross-linking agent such as MDI dispersed beforehand in paraffin, under rapid mixing, at 50° C., until the inorganic compound is microencapsulated.

The method according to the invention comprises an additional operation, following operation vi), that consists of maintaining in dispersion the microspheres containing salt by mechanical agitation.

The step of microencapsulation of salt in a paraffinic medium of the multi-core microcapsule synthesis method will be better understood upon consideration of the description, which refers to the following non-limiting examples.

### EXAMPLE 4

### Salt-in-Paraffin Emulsion: Emulsion E1

In one embodiment, during the emulsification of E1, the aqueous phase, comprised of hydrate salt and water in a proportion of 5:1, and the paraffin continuous phase, either hexadecane or eicosane with the surfactant mixture (5% by volume), are selected in such a way that the volume ratio of the phases is 1 to 4. The aqueous phase is dispersed in the organic phase using a high-shear homogenizer.

The protocol for forming emulsion E1 consists of dispersing 30 ml of a salt solution in 70 ml of hexadecane at 8,500 rpm for 15 minutes. A drop is sampled to observe its emulsion type and granulometry under an optical microscope. Stability is observed over a period of 24 hours at room temperature. The results of the observations are presented in table 3 (classification: +++=excellent; ++=good; +=satisfactory; −=insufficient; W=water; O=oil).

TABLE 3

| HLB | Emulsion type | Stability | Distribution |
|---|---|---|---|
| 2 | undefined | − | very broad |
| 3 | W/O | + | broad |
| 4 | W/O | + | narrow |
| 5 | W/O | ++ | very narrow |
| 6 | W/O | +++ | very narrow |
| 7 | W/O | ++ | very narrow |
| 8 | O/W/O | − | very broad |

The emulsion is produced at room temperature and the addition of a small amount of water to the salt solution makes it possible to lower its melting point, thus allowing good dispersion of the particles at a shearing speed of 8,500 rpm for 15 minutes, so as to obtain submicronic particles.

### EXAMPLE 5

### PVA-in-Hexadecane Emulsion: Emulsion E2

The various studies conducted on microencapsulation with a PVA (polyvinyl alcohol) membrane have shown that the size of the particles was primarily influenced by the emulsifier, the PVA concentration in the solution, and especially by shearing during emulsification. In fact, droplet granulometry is related to the physical parameters of the solution by the Weber equation.

Depending on the concentration of emulsifier in the solution, interfacial energy is likely to vary widely. At a low concentration interfacial energy is stable, but when concentration increases interfacial energy decreases logarithmically, reaching a limiting value at high concentrations. In the PVA/hexadecane system, concentrations between 1% and 10% are sufficiently high to achieve an interfacial energy value of approximately 0.6 mN/m. These measurements, obtained using the Du Nouy ring method, show that interfacial energy remains constant regardless of the PVA concentration in the solution, thus implying that emulsion droplet size variation is related to shearing forces and to the viscosity of the continuous and dispersed phases.

In fact, the viscoelastic force of the dispersed phase is part of the forces which prevent droplet fragmentation. The viscosity of the solution is a direct measurement of the viscoelastic force of the fluid. The increase in the viscosity of the dispersed phase requires greater shearing forces to prevent particle coalescence. Thus, a fine and stable emulsion is obtained when the ratio of viscosities is near 1, meaning a PVA concentration of less than 10%. Table 4 illustrates the dispersed phase/continuous phase viscosity ratios. Viscosities of the various solutions were determined at room temperature using a Brookfield viscometer at 20 rpm and at 20° C.

TABLE 4

| PVA (% by weight) | Ratio of viscosity with hexadecane |
|---|---|
| 20 | 30.3 |
| 15 | 13.9 |
| 10 | 3.2 |
| 5 | 0.9 |
| 2 | 0.5 |
| 1 | 0.3 |

This emulsification step is carried out at room temperature and at 13,500 rpm, thus ensuring that particles with a mean granulometry comparable to the first solution are obtained.

### EXAMPLE 6

### Creation of the Microgel

The production of a microgel during the mixing of emulsions E1 and E2 is related to the modification of the PVA network in water. The stability of the polymer is ensured by the presence of intramolecular and intermolecular hydrogen bonds. The presence of salt in a high concentration will modify the hydration of the PVA chains until the latter precipitate. Thus, the introduction of a large quantity of ions into the medium and the presence of strong intermolecular bonds are responsible for the destruction of the PVA/water network by the disruption of the hydrogen bonds between the hydroxyl groups of the polymer chains. Moreover, for the microspheres comprising the inorganic non-phase-change compounds, for example phosphate salts, the introduction of salt is also likely to lead to the formation of hydrogen bonds, in a small quantity, between the phosphate and the hydroxyl groups of the PVA, thus initially stabilizing the network in gel form. Thus, coacervation of the polymer in the solution results directly from the modification of polymer-polymer, polymer-solvent and polymer-ion interactions.

### EXAMPLE 7

### Cross-Linking of the Microgel by MDI

The use of these microparticles in gel form tends to destabilize the solution during final encapsulation by the aminoplast membrane. Thus, to avoid any coalescence or aggregation phenomena, chemical cross-linking of the gel was chosen to obtain solid particles. In general, PVA is easily cross-linked in an aqueous medium by the introduction of an aldehyde; being in an organic medium, the possibility of establishing polyurethane bonds by the action of MDI (4,4′-diphenylmethane diisocyanate) on PVA was studied.

The addition of MDI, dispersed beforehand in a small amount of paraffin, is carried out dropwise using a burette, under rapid agitation at 50° C.

At the end of this step, the microspheres of salt are maintained in dispersion in paraffin by mechanical agitation.

The step of the formation of microcapsules and of an aminoplast membrane of the multi-core microcapsule synthesis method comprises the following operations:
vii) introduce into a mixer a composition D comprising an aqueous phase containing an aqueous solution of aminoplast pre-polymer and a surfactant, for example Tween® 20, and a continuous phase comprising the inorganic compound microspheres in dispersion;
viii) operate the mixer at room temperature at a speed of approximately 10,500 rpm for approximately 15 min until a stable emulsion E3 is obtained,
ix) increase the temperature of emulsion E3 to approximately 55° C. and adjust the speed of the mixer to approximately 400 rpm for approximately 4 h so as to obtain microcapsules.

The method also comprises steps of filtering, washing and drying of the microcapsules obtained in step ix.

### Multi-Core Microcapsule Characterization

### Morphology and Size

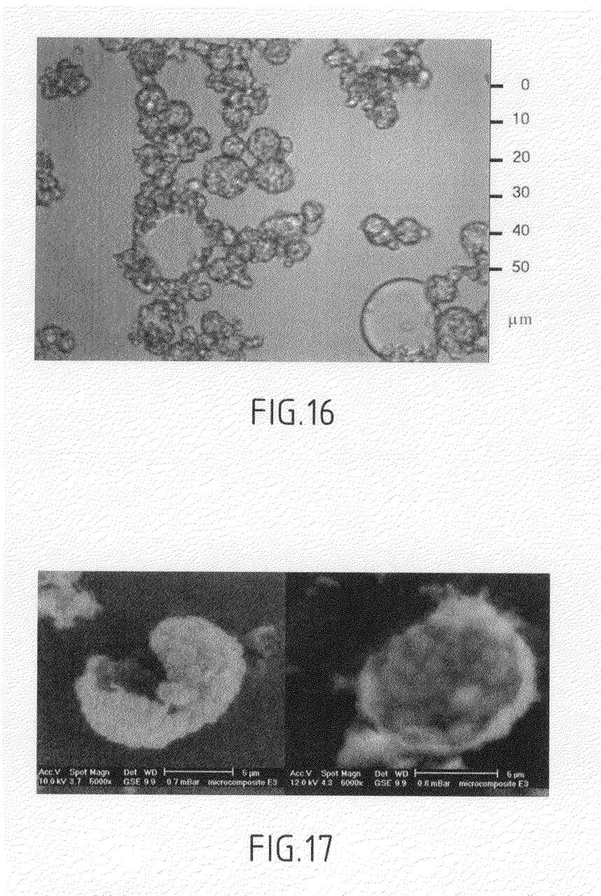

SEM observations (FIG. 15 presenting an SEM image (×5,000) of the microcapsules show the presence of a bimodal size distribution, the first with a mean diameter of approximately 1 μm and the second of 5 μm. The difference in granulometry is likely related to the presence or absence of microspheres of salt in the microcapsules. Indeed, during oil-continuous emulsion, the formation of paraffin droplets of small size, very stable thermodynamically, as well as larger droplets, was observed. The microcapsules are between 1 μm and 10 μm in diameter. The particles obtained do not appear perfectly spherical and their walls are granular. In addition, the image obtained by optical microscopy (FIG. 16 presenting an optical image (×64) of the microcapsules) suggests the presence of small particles inside the microcapsules.

### Multi-Core Microcapsule Structure

The multi-core microcapsules comprise at least one organic compound surrounded by microspheres comprising at least one inorganic compound; said microspheres are bound together by the amino resin. Dispersion of the microcapsules in a cyclohexane solution allowed selection of the large particles, which opened under the effect of mechanical pressure. SEM observations of these particles (FIG. 17 presenting two SEM images (×5,000 and ×6,000) of the microcapsules after rupture of the membrane) indeed show that microcapsules coated by a microsphere shell are obtained. Nevertheless, it appears that microspheres 30 are bound together by amino resin 60 thus forming a shell (wall) 70 encapsulating the paraffin (the reference numbers are given with respect to FIG. 14). This granular appearance, as well as the presence of small spheres inside the particles, can be observed. These microcapsules, whose mean diameter is 5 μm, enclose the microspheres, whose mean diameter is 1 μm.

In another embodiment, inorganic compound 40, which is contained inside microspheres 30 with PVA/MDI membranes 50 surrounding organic compound 20, is comprised of phosphate salts (FIG. 14). SEM observations of these particles (FIG. 23 presenting an SEM image (×4,000)) and the EDX elemental analysis appearing in table 5 below show that the microspheres thus obtained have a granulometry and a mean diameter distribution comparable to those for microspheres containing a hydrate salt (illustrated in FIG. 15).

TABLE 5

| Element | Wt % | At % | K-ratio | Z | A | F |
|---|---|---|---|---|---|---|
| C K | 60.25 | 70.33 | 0.2059 | 1.0168 | 0.336 | 1.0002 |
| O K | 24.19 | 21.2 | 0.0457 | 0.9999 | 0.189 | 1.0002 |
| Na K | 9.07 | 5.53 | 0.0407 | 0.9361 | 0.479 | 1.0006 |
| P K | 6.49 | 2.94 | 0.0536 | 0.9203 | 0.8987 | 1 |
| Total | 100 | 100 | | | | |

### Thermal Behavior

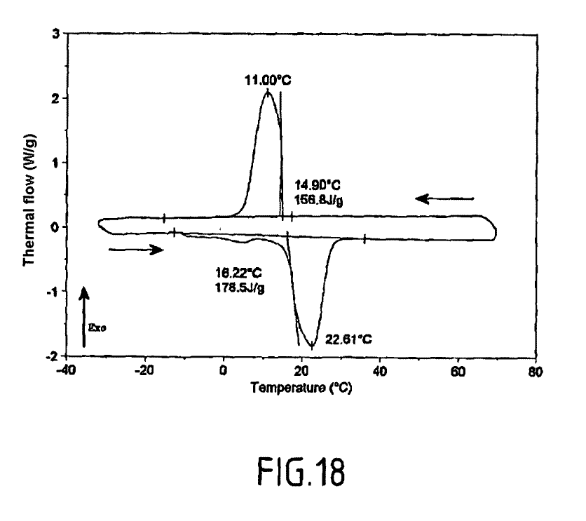

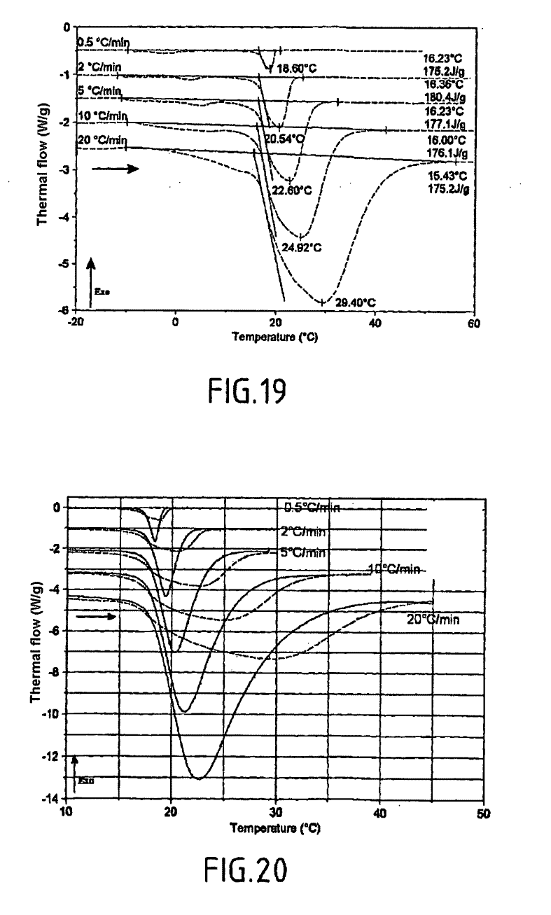

Thermal behavior of the microcapsules was evaluated by DSC analysis with various temperature ramps (0.5, 2, 5, 10 and 20° C./min) under nitrogen flow. The thermograms presented in FIGS. 18 and 19 demonstrate two distinct phenomena, one related to the phase change of microencapsulated paraffins and the other more particularly attributable to the membrane structure of the particles.

Firstly, the DSC analyses of these microcapsules revealed a phase-change enthalpy between 170 J/g and 180 J/g; the corresponding melting and crystallization temperatures of 16° C. and 15° C. are related to the presence of hexadecane (FIG. 18). Indeed, by only considering measurements taken at temperatures characteristic of paraffin, the enthalpies are on the order of 150 J/g to 160 J/g. By comparing this energy balance with that of paraffin alone, an encapsulation yield of 67.5% by weight is obtained; thus, all the paraffin introduced is found to be microencapsulated.

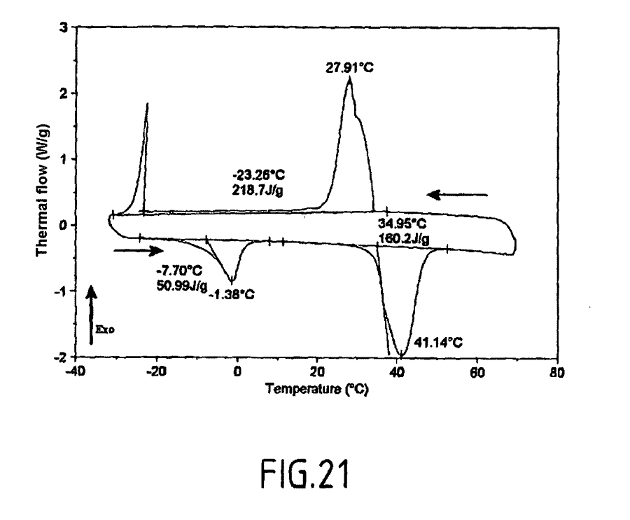

Analyzing the samples at various temperature ramps (FIG. 19) highlights the second thermal phenomenon, which is due to the incorporation in the final structure of salt/PVA microspheres bridged with MDI. A melting peak is observed between −10° C. and 10° C., with a mean enthalpy of 20 J/g. Comparison of the thermograms of the microcapsules with those of hexadecane (FIG. 20) also demonstrates an increase in the thermal window of melting of microencapsulated paraffin by a factor of 1.5. Taking into account the absence of a melting peak for the hydrate salt, it is worth considering that the presence of these microspheres in the membrane modify as a consequence the distribution of heat exchanges within the particles. The replacement of hexadecane by eicosane does not alter the appearance of the phenomenon; only the phenomena related to paraffin phase-changes are modified on the thermogram (FIG. 21).

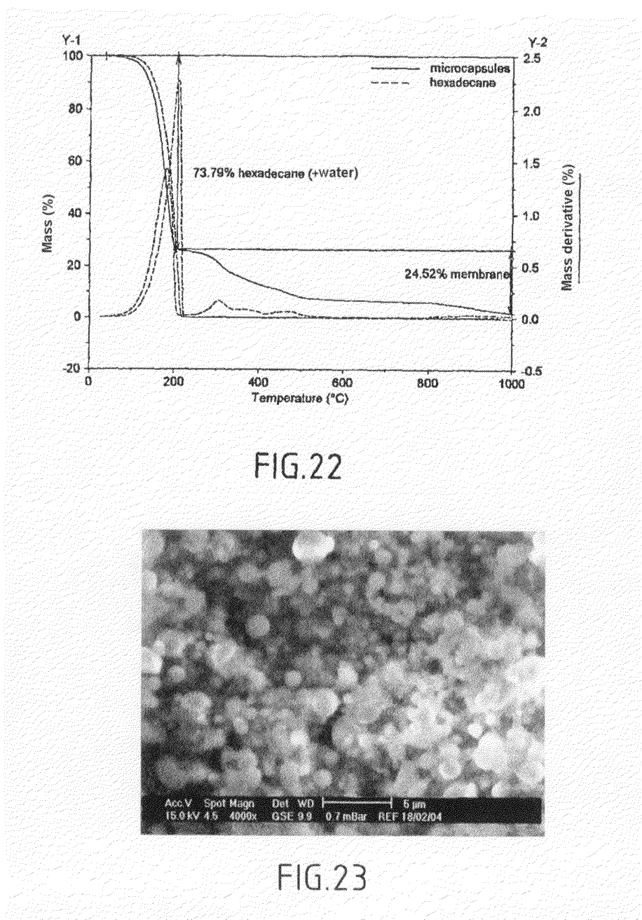

Thermogravimetric analysis of the microcapsules, at 10° C./min and under nitrogen (FIG. 22), shows a loss in mass of 73.5% that is attributable to the presence of paraffin and also to the water contained in the particles, given that its degradation begins before that of paraffin. Thus, it can be estimated that there is approximately 6% by weight of residual water present in the salt/PVA/MDI network. The salt/PVA/MDI complex forms a structure capable of storing energy by latent heat.

According to another aspect, the invention relates to compositions B and C implemented in the multi-core microcapsule synthesis method.

Composition B comprises two phases, a liquid phase containing an inorganic compound, for example a hydrate salt or phosphate salts, and water, in a proportion of 5:1, and a continuous phase containing paraffin and a 5% by volume surfactant mixture; the aqueous phase-continuous phase volume ratio of composition B is between 1 and 4.

Composition C comprises two phases, an aqueous phase containing an aqueous solution of PVA and a continuous phase containing a paraffin; the PVA weight concentration of composition C is lower than 10%.

Composition D comprises a dispersion of microcapsules containing salt in paraffin and an aqueous solution containing an aminoplast pre-polymer and a surfactant such as Tween® 20, wherein the aminoplast pre-polymer is approximately 30% by weight, the surfactant is approximately 5% by weight and the pH is approximately 3.

1. Single-core or multi-core aminoplast-membrane microcapsules comprised of at least two organic and/or inorganic compounds.

2. Microcapsules according to claim 1, wherein at least one of the organic and/or inorganic compounds is a phase-change compound.

3. Single-core microcapsules according to claim 1, wherein said microcapsules comprise a mixture of at least two paraffins.

4. Microcapsules according to claim 3, wherein the paraffins are even alkanes.

5. Microcapsules according to claim 4, wherein the alkanes are selected from the group comprising C16, C18 and C20.

6. Microcapsules according to claim 3, wherein said mixture is likely to change phase in a range of temperatures from 19° C. to 30° C.

7. Microcapsules according to claim 3, wherein said microcapsules also comprise a soluble load in any proportion in said mixture.

8. Microcapsules according to claim 7, wherein the load is tetraethylorthosilicate.

9. Microcapsules according to claim 3, wherein the weight concentration of the introduced paraffins is between 25% and 75%.

10. Microcapsules according to claim 3, wherein the thickness of the membrane of said microcapsules is between 120 nm and 700 nm.

11. Microcapsules according to claim 3, wherein the mean diameter of said microcapsules is approximately 5 μm.

12. A microcapsule synthesis method according to claim 3, wherein said method comprises the following steps:
a) introduce into a mixer, in an aqueous solution, a base composition A comprising:
a mixture of at least two paraffins,
an aminoplast pre-polymer,
a surfactant;
b) operate the mixer at a speed between 9,000 rpm and 14,000 rpm, at a temperature of approximately 40° C. and a pH of approximately 4 for 10 to 20 minutes, so as to emulsify and homogenize said composition, until a stable emulsion is obtained;
c) increase the temperature of the emulsion to approximately 55° C. and adjust the speed of the mixer to approximately 600 rpm for approximately 4 hours so as to obtain microcapsules.
d)

13. A method according to claim 12, wherein said method comprises the steps of filtering, washing and drying of the microcapsules obtained in step c.

14. A base composition A implemented in the microcapsule synthesis method according to claim 12, wherein said composition comprises, in an aqueous solution:
a blended mixture of at least two paraffins,
an aminoplast pre-polymer,
a surfactant,
optionally a soluble load in said mixture,
and wherein the mixture ratio of paraffins to pre-polymer aminoplast is between 20% and 80% by weight.

15. A composition according to claim 14, wherein said surfactant is a mixture (50/50 by volume) of Tween® 20 and Brij® 35, at 4% by weight with respect to the aqueous phase.

16. A composition according to claim 14, wherein said aminoplast pre-polymer has a formaldehyde/melamine molar ratio greater than 4.

17. Microcapsules according to claim 1, wherein said microcapsules comprise at least one organic compound surrounded by microspheres comprising at least one inorganic compound, said microspheres being bound together by the amino resin.

18. Microcapsules according to claim 17, wherein said organic compound is a paraffin.

19. Microcapsules according to claim 18, wherein said paraffin is hexadecane.

20. Microcapsules according to claim 19, wherein said paraffin is eicosane.

21. Microcapsules according to claim 17, wherein said inorganic compound is a hydrate salt.

22. Microcapsules according to claim 17, wherein said inorganic compound is a phosphate salt.

23. Microcapsules according to claim 17, wherein said microspheres have a PVA/MDI membrane.

24. Microcapsules according to claim 17, wherein the diameter of said microcapsules is between 1 μm and 10 μm.

25. A microcapsule synthesis method according to claim 17, wherein said method comprises:
a step of microencapsulation of the inorganic compound in a paraffinic medium; and
a step of formation of microcapsules and of synthesis of the aminoplast membrane.

26. A method according to claim 25, wherein the step of microencapsulation of the inorganic compound in a paraffinic medium comprises the following operations:
i) introduce into a first mixer a composition B comprising two phases, an aqueous phase containing an inorganic compound and water and a continuous phase containing paraffin and a mixture of surfactants, the mixture of surfactants having an HLB (hydrophilic-lipophilic balance) between 5 and 7,
ii) operate the first mixer at a speed of 8,500 rpm for approximately 15 min at approximately room temperature so as to emulsify composition B until a stable emulsion E1 is obtained,
iii) introduce into a second mixer a composition C comprised of two phases, an aqueous phase containing an aqueous solution of PVA and a continuous phase containing a paraffin;
iv) operate the second mixer at room temperature at a speed of approximately 13,500 rpm so as to emulsify composition C until a stable emulsion E2 is obtained,
v) mix emulsions E1 and E2 to obtain a microgel,
vi) add to the microgel a cross-linking agent such as MDI dispersed beforehand in paraffin, under rapid mixing, at 50° C., until the inorganic compound is microencapsulated.

27. A method according to claim 26, wherein said method comprises an additional operation, following operation vi), that consists of maintaining in dispersion the microspheres containing salt by mechanical agitation.

28. A method according to claim 25, wherein the step of formation of microcapsules and of an aminoplast membrane comprises the following operations:
vii) introduce into a mixer a composition D comprising an aqueous phase containing an aqueous solution of aminoplast pre-polymer and a surfactant, for example Tween® 20, and a continuous phase comprising the inorganic compound microspheres in dispersion;
viii) operate the mixer at room temperature at a speed of approximately 10,500 rpm for approximately 15 min until a stable emulsion E3 is obtained,
ix) increase the temperature of emulsion E3 to approximately 55° C. and adjust the speed of the mixer to approximately 400 rpm for approximately 4 h so as to obtain microcapsules.

29. A method according to claim 28, wherein said method comprises of the steps of filtering, washing and drying of the microcapsules obtained in step ix.

30. A composition B implemented in the microcapsule synthesis method according to claim 26, wherein said composition B comprises two phases, a liquid phase containing an inorganic compound and water, in a proportion of 5:1, and a continuous phase containing paraffin and a 5% by volume surfactant mixture, and wherein the aqueous phase-continuous phase volume ratio of composition B is between 1 and 4.

31. A composition C implemented in the microcapsule synthesis method according to claim 26, wherein said composition C comprises two phases, an aqueous phase containing an aqueous solution of PVA and a continuous phase containing a paraffin, and wherein the PVA weight concentration of composition C is lower than 10%.

32. A composition D implemented in the microcapsule synthesis method according to claim 26, wherein said composition D comprises a dispersion of microcapsules containing salt in paraffin and an aqueous solution containing an aminoplast pre-polymer and a surfactant, and wherein the aminoplast pre-polymer is approximately 30% by weight, the surfactant is approximately 5% by weight and the pH is approximately 3.
